(19) United States
(12) Patent Application Publication
(10) Pub. No.: US 2009/0307225 A1
(43) Pub. Date: Dec. 10, 2009

(54) METHODS AND SYSTEMS FOR FACILITATING ACCESS TO A SCHEMA

(75) Inventors: Ian Shaw Burnett, New South Wales (AU); Stephen James Davis, New South Wales (AU)

Correspondence Address: KNOBBE MARTENS OLSON & BEAR LLP, 2040 MAIN STREET, FOURTEENTH FLOOR, IRVINE, CA, 92614, US

(73) Assignee: Smart Internet Technology CRC Pty Ltd., Eveleigh NSW (AU)

(21) Appl. No.: 12/089,367

(22) PCT Filed: Oct. 6, 2006
(86) PCT No.: PCT/AU2006/001474

§ 371 Date: Feb. 10, 2009

(30) Foreign Application Priority Data
Oct. 6, 2005 (AU) 2005905550

(51) Int. Cl. G06F 17/30; G06F 7/00

(52) U.S. Cl. 707/10; 707/100; 707/E17.032; 707/E17.044

(57) ABSTRACT

A method of facilitating access to a schema, the method comprising the steps of receiving a request from a first computing device for at least one fragment of the schema; identifying a second computing device that has access to the fragment of the schema; and providing the first computing device with a datum that enables the first computing device to retrieve the fragment of the schema from the second computing device to thereby facilitate access to the schema.

### FIELD OF THE INVENTION

The present invention relates generally to the field of schemas and more particularly, but by no means exclusively, to the field of facilitating access to a schema in a peer-to-peer network.

### BACKGROUND OF THE INVENTION

A schema, which is usually in the form of an electronic file, is used to provide a computer readable description of the structure of electronic data. Schemas have been used in a variety of areas including, for example, describing the set of structural and value constraints applicable to eXtensible Mark-up Language (XML) documents. Numerous schema languages have been developed including, for example, XML Schema.

It is not uncommon for a single schema file to describe many distinct pieces of data. Unfortunately, a computer that is only interested in processing some and not all of the distinct pieces of data will need to obtain and process the entire associated schema file. As a result a computer can consume unnecessary computing resources (for example, bandwidth and processing power) on superfluous parts of the schema file; that is, parts of the schema file that are not relevant to the pieces of data that a computer wishes to process.

### SUMMARY OF THE INVENTION

According to a first aspect of the present invention there is provided a method of facilitating access to a schema, the method comprising the steps of:

receiving a request from a first computing device for at least one fragment of the schema;

identifying a second computing device that has access to the fragment of the schema; and

providing the first computing device with a datum that enables the first computing device to retrieve the fragment of the schema from the second computing device to thereby facilitate access to the schema.

An embodiment of the present invention provides an advantage of allowing the first computing device to selectively retrieve only those parts (fragments) of the schema that it requires. In contrast, existing schema access technologies would require the first computing device to obtain the entire schema file, which may mean that the first computing device will need to process many parts of the schema that are superfluous to its needs. Being able to retrieve only required parts of the schema has the potential to conserve bandwidth as the first computer only retrieves required fragments of the schema from the second computer. Furthermore, the ability to selectively retrieve required parts of the schema means that the first computing device can avoid expending unnecessary processing resources on handling parts of the schema that are not required.

Preferably, the method further comprises the steps of:

determining that a change to the fragment of the schema is to be made; and
providing the first computing device with a first notification concerning the change.

In an embodiment of the present invention, being able to determine that the change to the schema is to be made is advantageous for several reasons. For instance, it enables the schema to be dynamic in nature; that is, the schema can change over time. Notifying the first computing device about the change to the schema is desirable because it provides a means for ensuring the first computing device is not using an out-of-date version of the fragment of the schema. Subsequent to being notified about the change to the schema the first computing device can request the updated version by, for example, reissuing the request for the fragment.

Preferably, the step of determining that the change to the fragment of the schema is to be made comprises the steps of:

assessing a number of requests for the fragment of the schema; and

assessing whether the second computing device is connected to a network.

In an embodiment of the present invention, assessing the number of request is useful when it comes to determining that the change to the fragment of the schema is to be made. For instance, if the assessment of the number of requests reveals that very few requests for the fragment have been received it may be assumed that the fragment of the schema is no longer required. As such, the notification provided to the first computing device may indicate that the fragment is no longer part of the schema. Alternatively, if the assessment of whether the second computer is connected to the network indicates that the second computer has disconnected from the network the notification issued to the first computing device can also indicate that the fragment is no longer part of the schema.

Preferably, the method further comprises the step of receiving a second notification indicating that the second computing device has the fragment of the schema.

In an embodiment of the present invention, the ability to receive the notification is desirable because it provides a mechanism for allowing the second computing device to advertise the fact that it has access to the fragment of the schema.

According to a second aspect of the present invention there is provided a method of facilitating access to a schema, the method comprising the steps of:

identifying a system that is arranged to facilitate access to the schema;

sending a request to the system for at least one fragment of the schema; and

receiving from the system a datum that enables the fragment of the schema to be retrieved from a computing device to thereby facilitate access to the schema.

In an embodiment of the present invention, the method according to the second aspect of the present invention provides the same advantage as the same method according to the first aspect of the present invention. However, the embodiment of the method of the first aspect of the present invention is better suited to being performed by a computing device that wishes to use the fragment of the schema (such as, for example, a peer computing device in a peer-to-peer network). In contrast, the embodiment of the method according to the first aspect of the present invention is suitable for use by a server computer.

Preferably, the method further comprises the steps of:

receiving a first notification about a change to the schema that affects the fragment of the schema; and

responding to the notification in order to effect the change.

In an embodiment of the present invention, the step of responding to the first notification is desirable as it provides a means for ensuring that an up-to-date schema is being used.

Preferably, the method further comprises the step of providing the system with a second notification indicating that the computing device has the fragment of the schema.

In an embodiment of the present invention, providing the system with the second notification is desirable as it provides a means for informing the system that access to the other fragment can be provided should it be required by, for example, a computing device.

Preferably, the step of identifying the system comprises the step of processing data for which the schema was created in order to identify the system.

According to a third aspect of the present invention there is provided a system for facilitating access to a schema, the system comprising a processing means arranged to perform the steps of:

receiving a request from a first computing device for at least one fragment of the schema;

identifying a second computing device that has access to the fragment of the schema; and

providing the first computing device with a datum that enables the first computing device to retrieve the fragment of the schema from the second computing device to thereby facilitate access to the schema.

Preferably, the processing means is further arranged to perform the steps of:

determining that a change to the fragment of the schema is to be made; and

providing the first computing device with a first notification concerning the change.

Preferably, the processing means is arranged such that the step of determining that the change to the fragment of the schema is to be made comprises the steps of:

assessing a number of requests for the fragment of the schema; and

assessing whether the second computing device is connected to a network.

Preferably, the processing means is further arranged to perform the step of receiving a second notification indicating that the second computing device has the fragment of the schema.

According to a fourth aspect of the present invention there is provided a system for facilitating access to a schema, the system comprising a processing means arranged to perform the steps of:

identifying another system that is arranged to facilitate access to the schema;

sending a request to the other system for at least one fragment of the schema; and

receiving from the other system a datum that enables the fragment of the schema to be retrieved from a computing device to thereby facilitate access to the schema.

Preferably, the processing means is further arranged to perform the steps of:

receiving a first notification about a change to the schema that affects the fragment of the schema; and

responding to the notification in order to effect the change.

Preferably, the processing means is further arranged to perform the step of providing the other system with a second notification indicating that the computing device has the fragments of the schema.

Preferably, the processing means is arranged such that the step of identifying the other system comprises the step of processing data for which the schema was created in order to identify the other system.

According to a fifth aspect of the present invention there is provided software comprising at least one instruction, which when executed by a computing device allows the computing device to perform the method according to the first aspect of the present invention or the method according to the second aspect of the present invention.

According to a sixth aspect of the present invention there is provided a computer readable medium comprising the software according to the fifth aspect of the present invention.

### A BRIEF DESCRIPTION OF THE DRAWINGS

Notwithstanding any other embodiments that may fall within the scope of the present invention, a particular embodiment of the present invention will now be described, by way of example only, with reference to the accompanying figures, in which:

FIGS. 1(a) and 1(b) each provide a schematic diagram of a computer network in accordance with an embodiment of the present invention;

FIG. 2 is a flow chart of various steps performed by the system of FIGS. 1(a) and 1(b) in accordance with an embodiment of the present invention;

FIG. 3 is another flow chart of steps performed by the system of FIGS. 1(a) and 1(b) in accordance with an embodiment of the present invention;

FIG. 4 shows data used by the system of FIGS. 1(a) and (b) in accordance with an embodiment of the present invention; and

FIG. 5 is another flow chart of steps performed by the system of FIGS. 1(a) and 1(b) in accordance with an embodiment of the present invention.

### AN EMBODIMENT OF THE INVENTION

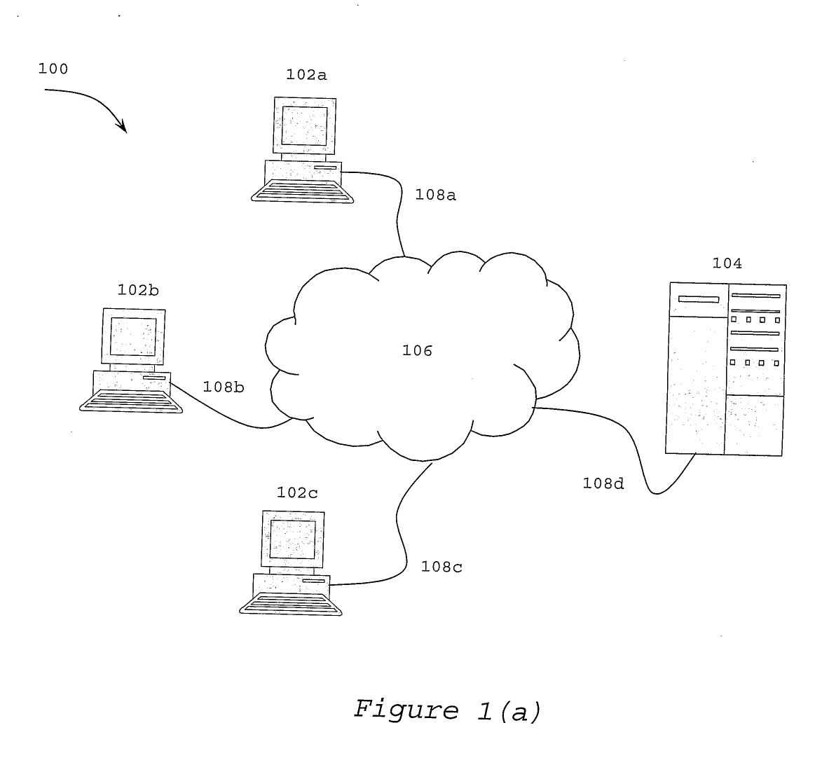

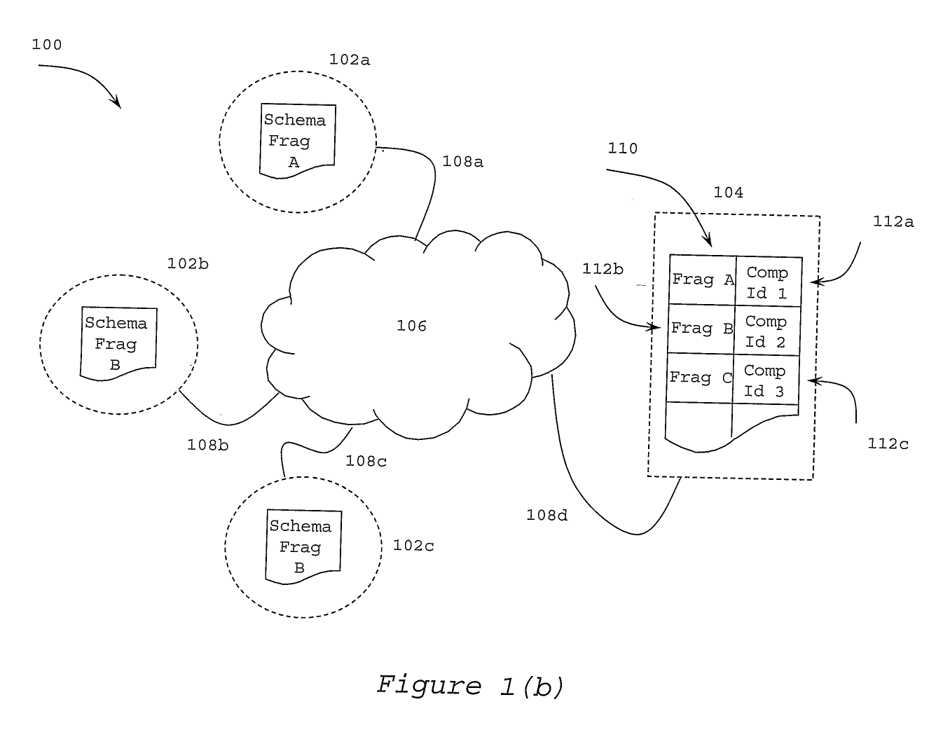

With reference to FIG. 1, a computer system 100 in accordance with an embodiment of the present invention comprises several computer devices 102, a computer server 104, a computer network 106, and data links 108 each of which is electrically coupled to one of the computing devices 102 and the computer network 106.

In the present embodiment of the invention each computer device 102 is in the form of a desktop personal computer. The computer devices 102 are arranged to operate as peers in a peer-to-peer network. It will be appreciated that while the present embodiment of the invention is not limited to desktop personal computers and that the computer devices 102 may well comprises a variety of different computer devices such as, for example, personal digital assistants and laptops. The computer network 106 is in the form of the Internet. The present invention is not restricted to being used with the Internet and can be used with other forms of computer networks such as, for example, a private local area network. Each data link 108 is in the form of a wired link such as an ADSL link. It will be appreciated, however, that the present invention is not restricted to being used with wired links and can be used in conjunction with wireless links such as those supported by the IEEE 802.11 standard.

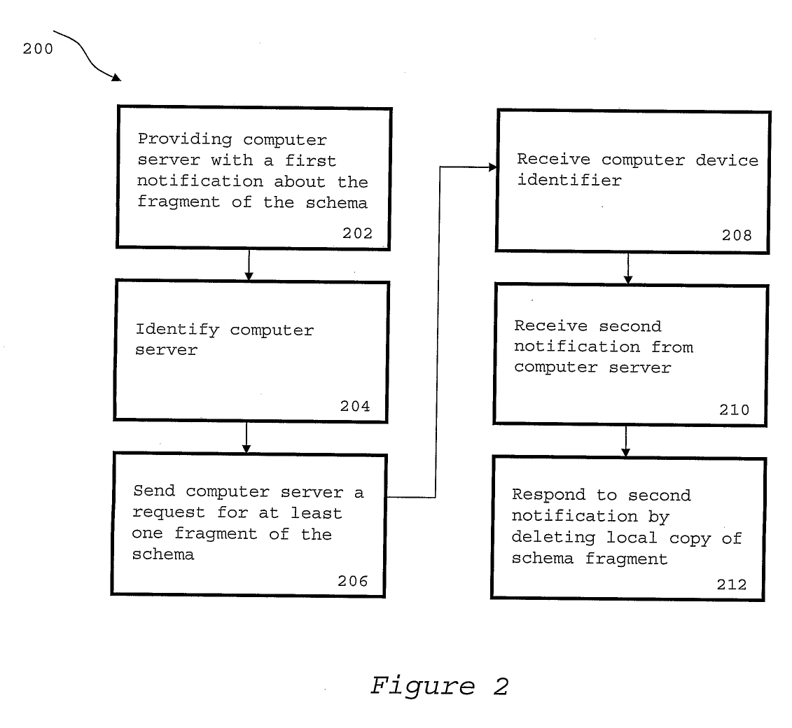

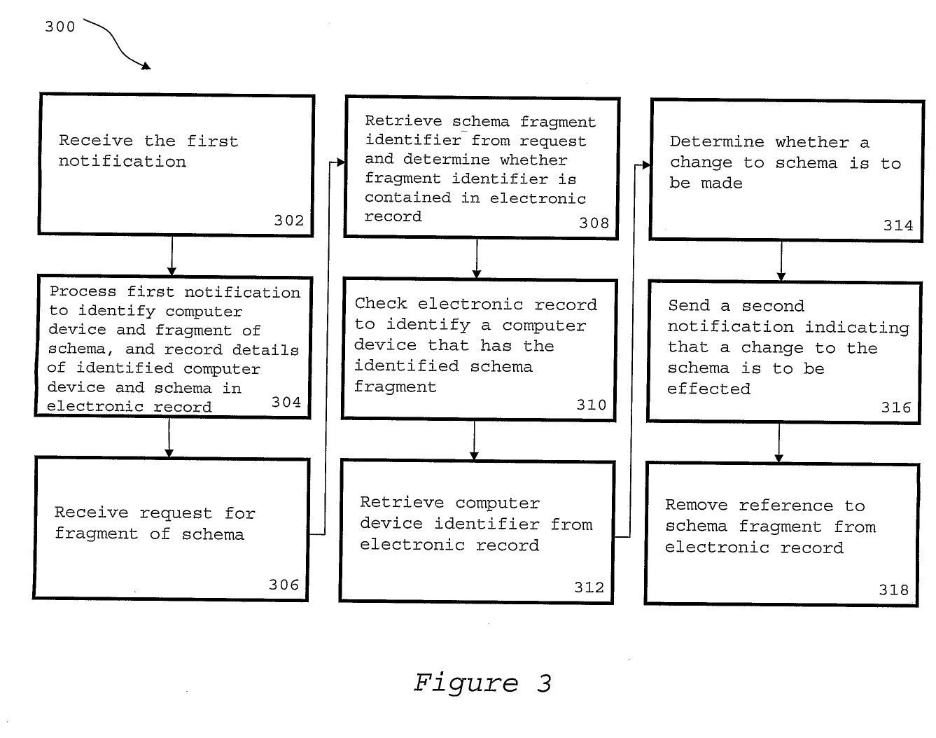

The computer devices 102 and the computer server 104 each comprise a processing means in the form of software. Essentially, the processing means of the computer devices 102 and the processing means of the computer server 104 cooperate with each other to enable the computer devices 102 to access a schema, which is in the form of an XML Schema file. It will be appreciated that the present invention is not restricted to XML Schema and can be used with other schema languages including, for example, Document Type Definitions (DTD) and Relax NG. The schema is made-up of fragments that are distributed across the computer devices 102. Each fragment of the schema can, for example, describe distinct XML documents or different parts of a single XML document. The various steps performed by the processing means of the computing devices 102 are shown in the flow chart 200 of FIG. 2, while the steps performed by the processing means of the computer server 104 are shown in the flow chart 300 of FIG. 3.

An initial step 202 that is performed by the processing means of a computer device 102 is to provide the computer server 104 with a first notification indicating that the computer device 102 has at least one fragment of the schema, which is stored on the hard disk of the computer device 102. The first notification, which is in the form of a data packet, is sent from the computer device 102 to the computer server 104 via the computer network 106. The first notification comprises an identifier of the computer device 102 (that is, the computer device 102 responsible for sending the first notification) and an identifier of the fragment of the schema. The identifier of the computer device 102 is in the form of a network address of the computer device 102 responsible for sending the first notification. The identifier of the fragment of the schema is in the form of a filename of the fragment of the schema.

In view of the fact that the processing means of a computer device 102 performs the step 202 of providing the computer server 104 with the first notification, the processing means of the computer server 104 is arranged to perform the step 302 of receiving the first notification. Subsequent to receiving the first notification from a computer device 102, the processing means of the computer server 104 performs the step 304 of processing the first notification to obtain the identifier of a computer device 102 and the identifier of the fragment of the schema, and recording the identifiers in an electronic record 110 (which can be seen in FIG. 1(b)). In relation to the electronic record 110 depicted in FIG. 1(b) it is noted that the record 110 comprises several entries 112. Each entry 112 identifies the fragment held by each of the computer devices 102. In this regard the record 110 identifies the fragments as “Frag A”, “Frag B”, and “Frag C”. The record 110 also identifies the computer device 102 that has the respective fragments. In this regard the computer devices 102 are identified as “Comp Id 1”, “Comp Id 2”, and “Comp Id 3”.

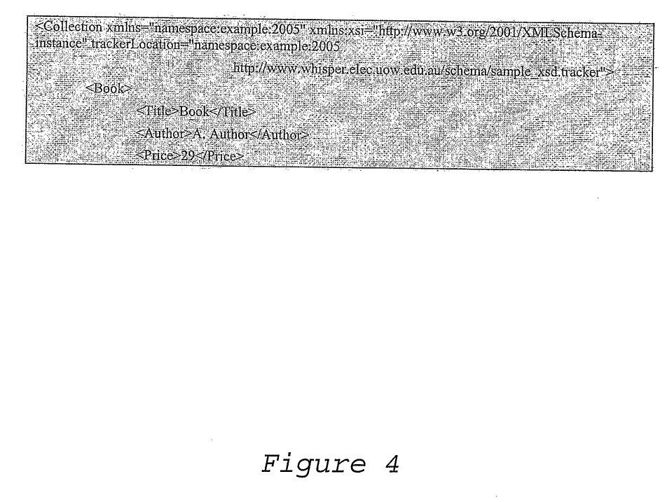

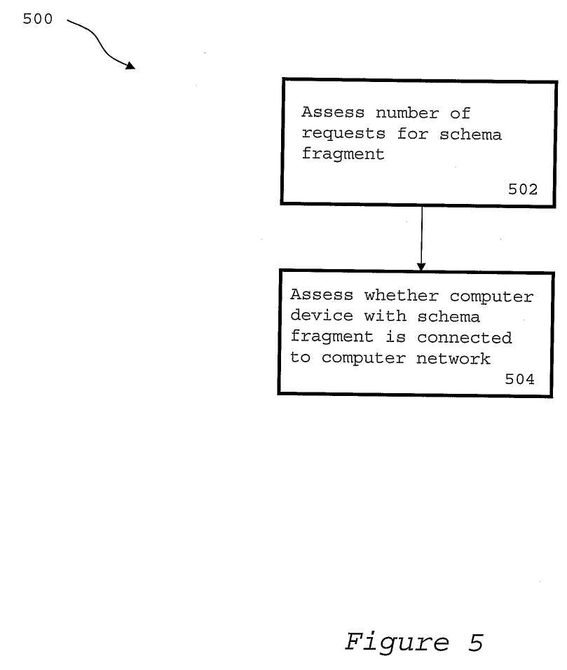

When a computing device 102 requires one or more fragments of the schema, the processing means of the computer device 102 performs the step 204 of identifying the computer server 104. To identify the computer server 104 the processing means examines the data (for example, an XML document) for which the schema was created to obtain a Uniform Resource Locator (URL) that identifies the Internet domain name of the computer server 104. In this regard, FIG. 4 shows an extract of the data showing the URL included in the “Collection xmlns” attribute.

Subsequent to identifying the computer server 104, the processing means of the computer device 102 uses the URL to perform the step 206 of sending a request to the computer server 104 for at least one fragment of the schema. The request comprises an identifier of the fragment of the schema required by the computer device 102. The identifier is in the form of an XPath expression. The request is in the form of a data packet, and is sent to the computer server 104 via the computer network 106.

Given that the processing means of the computer device 102 is capable of sending a request to the computer server 104 for a fragment of the schema, the processing means of the computer server 104 is arranged to perform the step 306 of receiving the request sent from the computer device 102 via the computer network 106. After receiving the request for a schema fragment the processing means of the computer server 104 performs the step 308 of retrieving the fragment identifier from the request, and determining whether the electronic record 110 contain an entry 112b that corresponds to the fragment identifier. In relation to the record 110 shown in FIG. 1(b) this step 308 involves checking whether the fragment identifier corresponds to the “Frag A”, “Frag B”, or “Frag C” entries 112b.

On determining that the electronic record 110 contains an entry 112b that corresponds to the fragment identifier retrieved from the request for a fragment of the schema, the processing means of the computer server 104 proceeds to perform the step 310 of examining the electronic record 110 to identify a computing device 102 that has the schema fragment identified in the request received during an earlier step 306. Examining the electronic record 110 to identify the computing device 102 basically involves examining another entry 112a, of the electronic record 110, that is associated with the original entry 112b found during a preceding step 308. In relation to the record 110 shown in FIG. 1(b), if the original entry 112b found during the preceding step 308 was “Frag B” then the entry 112a associated with the original entry would be “Comp Id 2”.

At this point the processing means of the computer server 104 performs the step 312 of retrieving from the other entry 112a of the record 110 the identifier of a computer device 102, and sending the identifier to the computer device 102 from which the request for the fragment was received. The identifier is sent from the computer server 104 to the computer device 102 in a data packet via the computer network 106. The identifier of the computer device 102 is in the form of a network address of the computer device 102. In relation to the electronic record 110 identified in FIG. 1(b), the identifiers of the computer devices 102 are represented as “Comp Id 1”, “Comp Id 2” and “Comp Id 3”.

In view of the fact that the processing means of the computer server 104 performs the step 312 of providing the computer device 102 with the identifier of another computer device 102, the processing means of each computer device 102 is arranged to perform the step 208 of receiving the identifier, via the computer network 106, from the computer server 104. Once the computer device 102 has received the identifier it can use the identifier to contact the appropriate computer device 102 from which the fragment of the schema that was requested during an earlier step 206 can be retrieved. More specifically, the processing means of the computer device 102 uses the identifier (which as mentioned earlier is in the form of a network address) to send a schema fragment request packet, via the computer network 106, to the computer device 102 that has the fragment of schema. In response to receiving the schema fragment request packet, the recipient computer device 102 provides the requesting computer device 102 with the requested fragment of the schema via the computer network 106.

The processing means of the computer server 104 is also arranged to perform the step 314 of determining whether a change to the schema is to be made. More specifically this step 314 involves several sub-steps 502 and 504, which are shown in the flow chart 500 of FIG. 1. The first sub-step 502 involves assessing a number of requests for a fragment of the schema (which are received during an earlier step 306). The second sub-step 504 involves assessing whether a computer device 102 that issued the first notification (which was received during an earlier step 302) is connected to the computer network 106.

In the event it is determined that the number of requests for the fragment is below a predefined threshold and/or the computer device 102 is not connected to the computer network 106, the processing means of the server computer 104 proceeds to carry out the step 316 of providing those computer devices 102 with a second notification indicating that a change to the schema is to be effected. The second notification is sent as a data packet to the computer devices 102 via the computer network 106. The notification identifies a fragment of the schema as an XPath expression. In this regard, the processing means of the computer server 104 is arranged to perform the step 318 of deleting from the electronic record 110 the entries 112a and 112b related to the schema fragment identified in the second notification. With reference to the electronic record 110 shown in FIG. 1(b), this step 318 would, for example, involve deleting the entries “Frag A” 112b and “Comp Id 1” 112a.

As a consequence of the processing means of the server computer 104 carrying out the previous step 316, the processing means of the computer devices 102 are arranged to perform the step 210 of receiving the second notification. Subsequent to performing the last step 210 the processing means of the computer devices 102 are arranged to perform the step 212 of responding to the second notification by deleting its local copy of the fragment of schema (identified in the second notification), which may be stored in local cache memory.

It will be appreciated by those skilled in the art that even though the present invention has been described in the context a schema that is distributed across several computers 102, the present invention is equally applicable to a schema that is located on a single computer and which is not distributed across numerous computers.

It will also be appreciated by persons skilled in the art that schema fragments of each of the computing devices may be the same or overlapping to provide redundancy.

While the present invention has been described with reference to the aforementioned embodiments, it will be understood by those skilled in the art that alterations, changes and improvements may be made and equivalents may be substituted for the elements thereof and steps thereof without departing from the scope of the present invention. In addition, many modifications may be made to adapt to a particular situation or material to the teachings of the present invention without departing from the central scope thereof. Such alterations, changes, modifications and improvements, though not expressly described above, are nevertheless intended and implied to be within the scope and spirit of the invention. Therefore, it is intended that the invention not be limited to the particular embodiments disclosed as the best mode contemplated for carrying out this invention, but that the invention will include all embodiments falling within the scope of the independent claims.

1. A method of facilitating access to a schema, the method comprising the steps of:
receiving a request from a first computing device for at least one fragment of the schema;
identifying a second computing device that has access to the fragment of the schema; and
providing the first computing device with a datum that enables the first computing device to retrieve the fragment of the schema from the second computing device to thereby facilitate access to the schema.

2. The method as claimed in claim 1, further comprises the steps of:
determining that a change to the fragment of the schema is to be made; and
providing the first computing device with a first notification concerning the change.

3. The method as claimed in claim 2, wherein the step of determining that the change to the fragment of the schema is to be made comprises the steps of:
assessing a number of requests for the fragment of the schema; and
assessing whether the second computing device is connected to a network.

4. The method as claimed in claim 1, further comprising the step of receiving a second notification indicating that the second computing device has the fragment of the schema.

5. A method of facilitating access to a schema, the method comprising the steps of:
identifying a system that is arranged to facilitate access to the schema;
sending a request to the system for at least one fragment of the schema; and
receiving from the system a datum that enables the fragment of the schema to be retrieved from a computing device to thereby facilitate access to the schema.

6. The method as claimed in claim 5, further comprising the steps of:
receiving a first notification about a change to the schema that affects the fragment of the schema; and
responding to the notification in order to effect the change.

7. The method as claimed in claim 5, further comprising the step of providing the system with a second notification indicating that the computing device has the fragment of the schema.

8. The method as claimed in claim 5, wherein the step of identifying the system comprises the step of processing data for which the schema was created in order to identify the system.

9. A system for facilitating access to a schema, the system comprising a processing means arranged to perform the steps of:
receiving a request from a first computing device for at least one fragment of the schema;
identifying a second computing device that has access to the fragment of the schema; and
providing the first computing device with a datum that enables the first computing device to retrieve the fragment of the schema from the second computing device to thereby facilitate access to the schema.

10. The system as claimed in claim 9, wherein the processing means is further arranged to perform the steps of:
determining that a change to the fragment of the schema is to be made; and
providing the first computing device with a first notification concerning the change.

11. The system as claimed in claim 10, wherein the processing means is arranged such that the step of determining that the change to the fragment of the schema is to be made comprises the steps of:
assessing a number of requests for the fragment of the schema; and
assessing whether the second computing device is connected to a network.

12. The system as claimed in claim 9, wherein the processing means is further arranged to perform the step of receiving a second notification indicating that the second computing device has the fragment of the schema.

13. A system for facilitating access to a schema, the system comprising a processing means arranged to perform the steps of:
identifying another system that is arranged to facilitate access to the schema;
sending a request to the other system for at least one fragment of the schema; and
receiving from the other system a datum that enables the fragment of the schema to be retrieved from a computing device to thereby facilitate access to the schema.

14. The system as claimed in claim 13, wherein the processing means is further arranged to perform the steps of:
receiving a first notification about a change to the schema that affects the fragment of the schema; and
responding to the notification in order to effect the change.

15. The system as claimed in claim 13, wherein the processing means is further arranged to perform the step of providing the other system with a second notification indicating that the computing device has the fragment of the schema.

16. The system as claimed in claim 13, wherein the processing means is arranged such that the step of identifying the other system comprises the step of processing data for which the schema was created in order to identify the other system.

17. Software comprising at least one instruction, which when executed by a computing device allows the computing device to perform the method as claimed in claim 1.

18. A computer readable medium comprising the software as claimed in claim 17.

19. (canceled)

20. (canceled)
